(19) United States
(12) Patent Application Publication
(10) Pub. No.: US 2023/0185617 A1
(43) Pub. Date: Jun. 15, 2023

(54) SYSTEM AND METHOD FOR TRIGGERING ONE OR MORE ACTIONS

(71) Applicant: The Toronto-Dominion Bank, Toronto (CA)

(72) Inventors: Romy MOGHAIZEL, Richmond Hill (CA); Jeremy John MCCONNELL, Ottawa (CA); Carmelyn Renosa SORIANO, Ottawa (CA); Patricia Shumin KO, Toronto (CA)

(73) Assignee: The Toronto-Dominion Bank, Toronto (CA)

(21) Appl. No.: 17/546,344

(22) Filed: Dec. 9, 2021

(51) Int. Cl. G06F 9/50; G06F 9/54; G06F 11/34

(52) U.S. Cl. CPC G06F 9/5033; G06F 9/542; G06F 11/3495

(57) ABSTRACT

A computer server system comprises a communications module; a processor coupled with the communications module; and a memory coupled to the processor and storing processor-executable instructions which, when executed by the processor, configure the processor to obtain trigger data identifying two or more resource types and criteria for triggering one or more actions associated with each of the two or more resource types; monitor resource consumption data to identify another resource type being provided to a resource requester; responsive to identifying the another resource type being provided to the resource requester, determine, based on the trigger data, one or more actions to be triggered; and trigger the one or more actions.

### TECHNICAL FIELD

The present application relates to systems and methods for triggering one or more actions.

### BACKGROUND

Resources may be provided to resource requesters. For example, computing resources may be provided to one or more software applications executing on a computer.

For resource management purposes, resource consumption data may be obtained. The resource consumption data may include a list of resource requesters and an amount of resources provided to each requester.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified schematic diagram showing components of a computing device;

FIG. 3 is a high-level schematic diagram of an example computer device;

FIG. 4 shows a simplified organization of software components stored in a memory of the example computer device of FIG. 3;

FIG. 5 is a table showing example resource consumption data according to an embodiment;

FIG. 6 is a flowchart showing operations performed by a server in triggering one or more actions according to an embodiment;

FIG. 7 is a flowchart showing operations performed by a server in obtaining trigger data according to an embodiment;

FIG. 8 is an example interface displayed on a display screen of a computing device according to an embodiment;

FIG. 9 is another example interface displayed on a display screen of a computing device according to an embodiment;

FIG. 10 is yet another example interface displayed on a display screen of a computing device according to an embodiment; and

FIG. 11 is a flowchart showing operations performed by a server in performing an action according to an embodiment.

Like reference numerals are used in the drawings to denote like elements and features.

### DETAILED DESCRIPTION OF VARIOUS EMBODIMENTS

Accordingly, in one aspect there is provided a computer server system comprising a communications module; a processor coupled with the communications module; and a memory coupled to the processor and storing processor-executable instructions which, when executed by the processor, configure the processor to obtain trigger data identifying two or more resource types and criteria for triggering one or more actions associated with each of the two or more resource types; monitor resource consumption data to identify another resource type being provided to a resource requester; responsive to identifying the another resource type being provided to the resource requester, determine, based on the trigger data, one or more actions to be triggered; and trigger the one or more actions.

In one or more embodiments, the criteria for triggering one or more actions includes identifying the another resource type being provided to the resource requester.

In one or more embodiments, the one or more actions include providing resources of at least one of the two or more resource types to at least one resource collector.

In one or more embodiments, the instructions, when executed, further configure the processor to determine an amount of the another resource type being provided to the resource requester; and provide an amount of the at least one of the two or more resource types to the at least one resource collector based on the amount of the another resource type being provided to the resource requester.

In one or more embodiments, the amount of the at least one of the two or more resource types is determined based on a modifier between the another resource type and the at least one of the two or more resource types.

In one or more embodiments, the trigger data defines the modifier between the another resource type and the at least one of the two or more resource types.

In one or more embodiments, the criteria for triggering the one or more actions includes triggering a first action associated with a first resource type of the two or more resource types in response to a first amount of the another resource type being provided to the resource requester and triggering a second action associated with a second resource type of the two or more resource types in response to a second amount of the another resource type being provided to the resource requester.

In one or more embodiments, the criteria for triggering the one or more actions includes triggering a first action associated with a first resource type of the two or more resource types in response to the another resource type being provided to a first resource requester and triggering a second action associated with a second resource type of the two or more resource types in response to the another resource type being provided to a second resource requester.

In one or more embodiments, the instructions, when executed, further configure the processor to send, via the communications module and to a computing device, a signal causing the computing device to display at least one interface that includes one or more interface elements for defining the trigger data; and receive, via the communications module and from the computing device, a signal that includes the defined trigger data.

In one or more embodiments, the resource consumption data includes resource consumption data stored in a database in association with a single account.

In another aspect there is provided a computer-implemented method comprising obtaining trigger data identifying two or more resource types and criteria for triggering an action associated with each of the two or more resource types; monitoring resource consumption data to identify another resource type being provided to a resource requester; responsive to identifying the another resource type being provided to the resource requester, determining, based on the trigger data, one or more actions to be triggered; and triggering the one or more actions.

In one or more embodiments, the criteria for triggering one or more actions includes identifying the another resource type being provided to the resource requester.

In one or more embodiments, the one or more actions include providing resources of at least one of the two or more resource types to at least one resource collector.

In one or more embodiments, the method further comprises determining an amount of the another resource type being provided to the resource requester; and providing an amount of the at least one of the two or more resource types to the at least one resource collector based on the amount of the another resource type being provided to the resource requester.

In one or more embodiments, the amount of the at least one of the two or more resource types is determined based on a modifier between the another resource type and the at least one of the two or more resource types.

In one or more embodiments, the trigger data defines the modifier between the another resource type and the at least one of the two or more resource types.

In one or more embodiments, the criteria for triggering the action includes triggering a first action associated with a first resource type of the two or more resource types in response to a first amount of the another resource type being provided to the resource requester and triggering a second action associated with a second resource type of the two or more resource types in response to a second amount of the another resource type being provided to the resource requester.

In one or more embodiments, the criteria for triggering the action includes triggering a first action associated with a first resource type of the two or more resource types in response to the another resource type being provided to a first resource requester and triggering a second action associated with a second resource type of the two or more resource types in response to the another resource type being provided to a second resource requester.

In one or more embodiments, the method further comprises sending, via a communications module and to a computing device, a signal causing the computing device to display at least one interface that includes one or more interface elements for defining the trigger data; and receiving, via the communications module and from the computing device, a signal that includes the defined trigger data.

According to another aspect there is provided a non-transitory computer readable storage medium comprising computer-executable instructions which, when executed, configure a processor to obtain trigger data identifying two or more resource types and criteria for triggering an action associated with each of the two or more resource types; monitor resource consumption data to identify another resource type being provided to a resource requester; responsive to identifying the another resource type being provided to the resource requester, determine, based on the trigger data, one or more actions to be triggered; and triggering the one or more actions.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

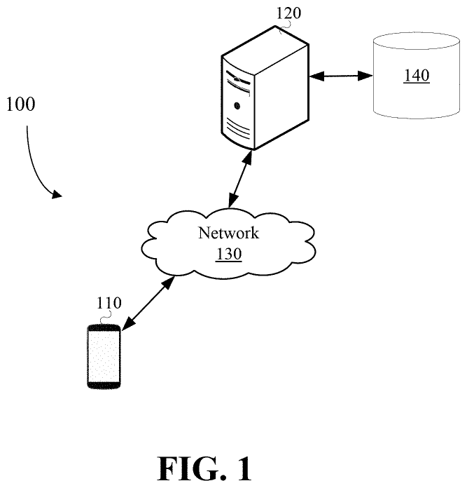

FIG. 1 is a schematic operation diagram illustrating an operating environment of an example embodiment. As shown, the system 100 includes a computing device 110 and a server 120 coupled to one another through a network 130, which may include a public network such as the Internet and/or a private network. The computing device 110 and the server 120 may be in geographically disparate locations. Put differently, the computing device 110 and the server 120 may be located remote from one another.

The computing device 110 may be a smartphone as shown in FIG. 1. However, the computing device 110 may be a computing device of another type such as for example a personal computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The server 120 is a computer server system. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

The computing device 110 may be adapted to receive, from the server 120, a signal that causes the computing device 110 to display an interface that allows for communication with the server 120.

The server 120 may be associated with or may communicate with a database 140 that stores data records. The data records may store resource consumption data that includes a list of resource requesters and an amount of resources provided to the resource requesters. The data records may be updated or maintained by the server 120 and this may be done each time resources are provided to a resource requester. The resource consumption data may be stored in the database 140 in association with an account. A resource requester may include computer processes, applications or data records that request resources.

In at least some embodiments, the resource consumption data may include a list of resource collectors and an amount of resources collected by the resource collectors. Resource collectors may include computer processes, applications or data records that collect or store resources.

The resources provided to the resource collectors may be of different types than the resources provided to the resource requesters. For example, a first resource type may be provided to a first resource collector, a second resource type may be provided to a second resource collector and a third resource type may be provided to the resource requesters. The amount of resources provided to the resource collectors may be associated with or based on the amount of resources provided to the resource requesters. For example, an amount of the first resource type may be provided to the first resource collector in response to an amount of the third resource type being provided to a resource requester. The amount of the first resource type may be determined based on the amount of the third resource type provided to the resource requester and based on a modifier between the first resource type and the third resource type.

The server 120 may communicate with the database 140 directly or through the network 130. The server 120 may communicate with one or more third party servers through the network 130 and the one or more third party servers may be associated with resource requesters and/or resource collectors.

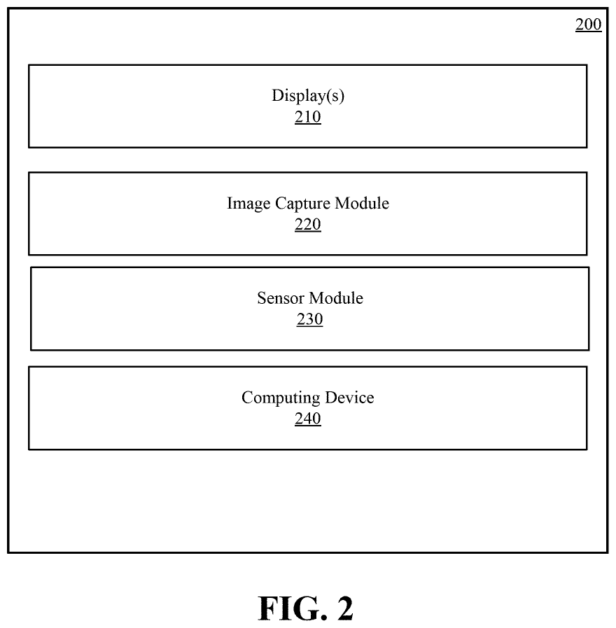

FIG. 2 is a simplified schematic diagram showing components of an exemplary computing device 200. The computing device 110 may be of the same type as computing device 200. The computing device 200 may include modules including, as illustrated, for example, one or more displays 210, an image capture module 220, a sensor module 230, and a computer device 240.

The one or more displays 210 are a display module. The one or more displays 210 are used to display screens of a graphical user interface that may be used, for example, to communicate with the server 120 (FIG. 1). The one or more displays 210 may be internal displays of the computing device 200 (e.g., disposed within a body of the computing device).

The image capture module 220 may be or may include a camera. The image capture module 220 may be used to obtain image data, such as images. The image capture module 220 may be or may include a digital image sensor system as, for example, a charge coupled device (CCD) or a complementary metal-oxide-semiconductor (CMOS) image sensor.

The sensor module 230 may be a sensor that generates sensor data based on a sensed condition. By way of example, the sensor module 230 may be or include a location subsystem which generates location data indicating a location of the computing device 200. The location may be the current geographic location of the computing device 200. The location subsystem may be or include any one or more of a global positioning system (GPS), an inertial navigation system (INS), a wireless (e.g., cellular) triangulation system, a beacon-based location system (such as a Bluetooth low energy beacon system), or a location subsystem of another type.

The computer device 240 is in communication with the one or more displays 210, the image capture module 220, and the sensor module 230. The computer device 240 may be or may include a processor which is coupled to the one or more displays 210, the image capture module 220, and/or the sensor module 230.

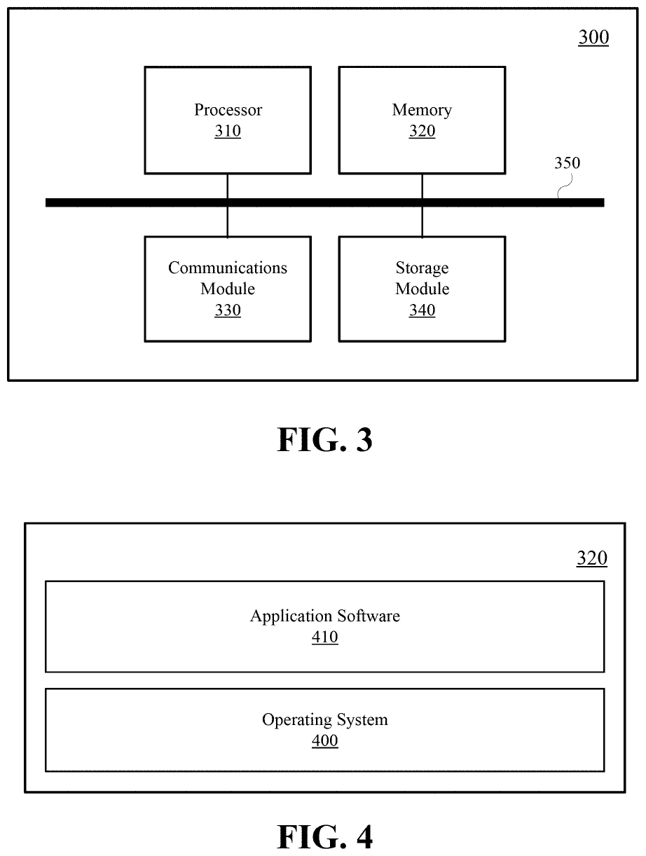

Referring now to FIG. 3, a high-level operation diagram of an example computer device 300 is shown. In some embodiments, the computer device 300 may be exemplary of the computer device 240 (FIG. 2) and/or server 120.

The example computer device 300 includes a variety of modules. For example, as illustrated, the example computer device 300 may include a processor 310, a memory 320, a communications module 330, and/or a storage module 340. As illustrated, the foregoing example modules of the example computer device 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are non-transitory computer-readable storage mediums. A computer-readable medium may be organized using a file system such as may be administered by an operating system governing overall operation of the example computer device 300.

The communications module 330 allows the example computer device 300 to communicate with other computer or computing devices and/or various communications networks. For example, the communications module 330 may allow the example computer device 300 to send or receive communications signals. Communications signals may be sent or received according to one or more protocols or according to one or more standards. For example, the communications module 330 may allow the example computer device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computer device 300 to communicate using near-field communication (NFC), via Wi-Fi™, using Bluetooth™ or via some combination of one or more networks or protocols. In some embodiments, all or a portion of the communications module 330 may be integrated into a component of the example computer device 300. For example, the communications module may be integrated into a communications chipset. In some embodiments, the communications module 330 may be omitted such as, for example, if sending and receiving communications is not required in a particular application.

The storage module 340 allows the example computer device 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the example computer device 300 (FIG. 3). As illustrated, these software components include an operating system 400 and an application 410.

The operating system 400 is software. The operating system 400 allows the application 410 to access the processor 310 (FIG. 3), the memory 320, and the communications module 330 of the example computer device 300 (FIG. 3). The operating system 400 may be, for example, Google™ Android™, Apple™ iOS™, UNIX™, Linux™, Microsoft™ Windows™, Apple OSX™ or the like.

The application 410 adapts the example computer device 300, in combination with the operating system 400, to operate as a device performing a particular function. For example, the application 410 may cooperate with the operating system 400 to adapt a suitable embodiment of the example computer device 300 to operate as the computer device 240 (FIG. 2) and/or the server 120.

While a single application 410 is illustrated in FIG. 3, in operation the memory 320 may include more than one application 410 and different applications 410 may perform different operations. For example, in at least some embodiments in which the computer device 300 is functioning as the computing device 110, the applications 410 may include a resource management application.

The resource management application may be configured to present one or more graphical user interfaces on a display of the computing device 110 and may provide various resource management functions. The resource management functions may include monitoring resource consumption data and/or setting or defining one or more triggers. For example, the resource management application may allow a user to define trigger data that may be used to trigger one or more actions. As will be described in more detail below, the trigger data may identify two or more resource types and criteria for triggering one or more actions associated with the two or more resource types.

The computing device 110 and/or the server 120 may monitor resource consumption data that includes a list of resource requesters and an amount of resources provided to the resource requesters. For example, the computing device 110 may identify a list of applications executing thereon and may determine the amount of computing resources being consumed by the applications. In this example, the computing resources may include a number of different resource types such as for example total processor utilization, physical memory in use, disk utilization, network utilization, graphic processing unit (GPU) utilization, and power usage. In one or more embodiments, the resource consumption data may be obtained from a computing resource application executing on the computing device 110.

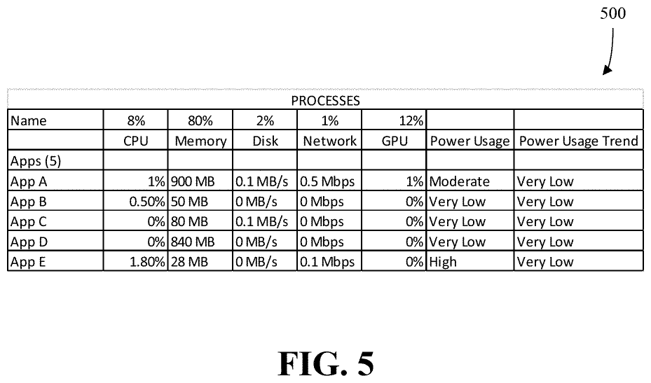

An example table 500 that includes resource consumption data is shown in FIG. 5. In this example, the resource requesters include applications executing on the computing device 110. As such, the table 500 includes a list of applications (“App A”, “App B”, “App C”, “App D”, “App E”) and resource consumption data identifying an amount of computing resources being consumed by or provided to each application.

The resource consumption data may be obtained in real-time and as such the amount of computing resources being consumed by each application may include a current amount of computing resources being consumed. The computing device 110 may store the resource consumption data in memory and/or may communicate the resource consumption data to the server 120 where it may be stored in the database 140. Although the resource consumption data is shown in FIG. 5 as a current amount of computing resources being consumed by each application, it will be appreciated that the computing device 110 may calculate or determine an average amount of resources being consumed by each application and the resource consumption data may include the average amount of resources being consumed by each application.

In one or more embodiments, the resource consumption data may be associated with a particular resource type. For example, the particular resource type may include network bandwidth. As such, the computing device 110 and/or the server 120 may generate the resource consumption data to include a list of resource requesters and an amount of network bandwidth consumed by or provided to each application. As another example, the particular resource type may include a value such as a quantity of resources associated with an account such as a credit card account. In this example, the server 120 and/or the database 140 may be associated with an entity such as for example a financial institution. The resource requesters may include third party accounts that request or otherwise receive a quantity of resources from the account. The quantity of resources requested by the resource requesters may be based on, for example, a transaction conducted between a third party associated with a third party account and a user associated with the credit card account. The third party may be, for example, a merchant.

The server 120 and/or the computing device 110 may perform operations to trigger one or more actions based on resources being provided to a resource requester.

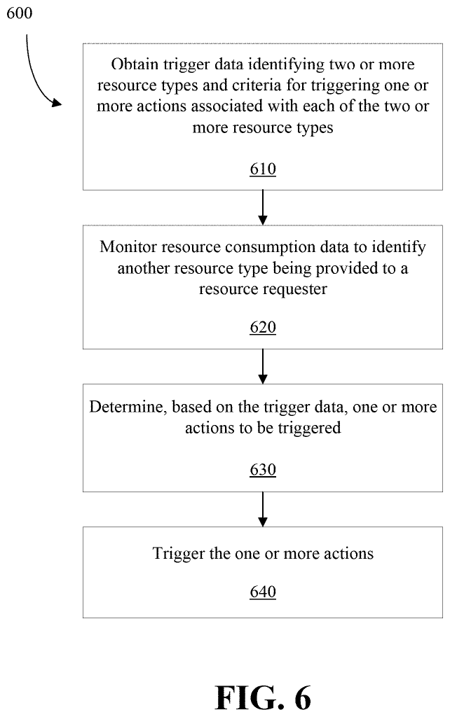

Reference is made to FIG. 6, which illustrates, in flowchart form, a method 600 for triggering one or more actions. The method 600 may be implemented by a computing device having suitable processor-executable instructions for causing the computing device to carry out the described operations. The method 600 may be implemented, in whole or in part, by the server 120. The server 120 may off-load some of the operations to the computing device 110.

The method 600 includes obtaining trigger data identifying two or more resource types and criteria for triggering one or more actions associated with each of the two or more resource types (step 610).

The trigger data may identify the two or more resource types, may define the criteria for triggering the one or more actions, and may define the one or more actions.

The two or more resource types are resource types that are associated with the one or more actions that are triggered. The two or more resource types are different resource types. The two or more resource types may include computing resource types such as for example total processor utilization, physical memory in use, disk utilization, network utilization, graphic processing unit (GPU) utilization, power usage, network bandwidth, etc. The two or more resource types may include, for example, loyalty point types such as for example a first loyalty point type, a second loyalty point type, etc.

The criteria for triggering the one or more actions may include identifying a particular resource type being provided to a resource requester. The particular type of resources is different than the two or more resource types associated with the one or more actions that are triggered. For example, the criteria for triggering the one or more actions may include determining a particular computing resource type being provided to or consumed by an application executing on the computing device. As another example, the criteria for triggering the one or more actions may include determining a quantity of a particular resource type being provided to a resource requester from a resource account.

The criteria for triggering the one or more actions may include triggering a first action associated with a first resource type in response to a first amount of the particular resource type being provided to a resource requester and triggering a second action associated with a second resource type in response to a second amount of the particular resource type being provided to the resource requester. The first amount and the second amount may be based on a threshold. For example, the first action may be triggered when an amount of the particular resource type being provided to the resource requester is less than the threshold and the second action may be triggered when an amount of the particular resource type being provided to the resource requester is greater than the threshold.

The criteria for triggering the one or more actions may include triggering a first action associated with a first resource type in response to the particular resource type being provided to a first resource requester and triggering a second action associated with a second resource type in response to the particular resource type being provided to a second resource requester. For example, the first action may be triggered when the particular resource type is provided to a first application executing on the computing device and the second action may be triggered when the particular resource type is provided to a second application executing on the computing device. As another example, the first action may be triggered when the particular resource type is provided to a first resource account associated with a first entity and the second action may be triggered when the particular resource type is provided to a second resource account associated with a second entity. The first entity and the second entity may be, for example, merchants or categories of merchants.

The one or more actions may include performing one or more computer operations. For example, in response to identifying a particular type of computing resource being provided to a resource requester, the one or more actions may include performing computer operations to clear out the memory cache of the computing device 110. As another example, in response to identifying a particular type of computing resource being provided to a resource requester, the one or more actions may include closing one or more other applications executing on the computing device and this may be based on, for example, GPU usage of the one or more applications. In this example, an application that is high in GPU usage may be closed to ensure GPU is available for one or more other applications executing on the computing device.

The one or more actions may include providing resources of at least one of the resource types to at least one resource collector. For example, resources of a first resource type may be provided to a first resource collector and resources of a second resource type may be provided to a second resource collector in response to identifying the particular resource type being provided to a resource requester. As another example, resources of a first resource type may be provided to a first resource collector in response to identifying the particular resource type being provided to a first resource requester and resources of a second resource type may be provided to a second resource collector in response to identifying the particular resource type being provided to a second resource requester. As yet another, resources of a first resource type may be provided to a first resource collector in response to identifying a first amount of resources being provided to a resource requester and resources of a second resource type may be provided to a second resource collector in response to identifying a second amount of resources being provided to a resource requester.

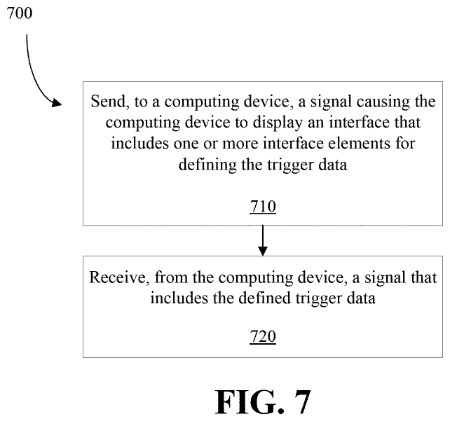

The trigger data may be defined by a user of the computing device 110 and may be stored in memory of the server 120 and/or in the database 140. Reference is made to FIG. 7, which illustrates, in flowchart form, a method 700 for obtaining the trigger data. The method 700 may be implemented by a computing device having suitable processor-executable instructions for causing the computing device to carry out the described operations. The method 700 may be implemented, in whole or in part, by the server 120. The server 120 may off-load some of the operations to the computing device 110.

The method 700 includes sending, to a computing device, a signal causing the computing device to display at least one interface that includes one or more interface elements for defining the trigger data (step 710).

The trigger data identifies two or more resource types, criteria for triggering one or more actions associated with the one or more resource types, and the one or more actions. As such, the at least one interface may be used to identify the two or more resource types, to define the criteria for triggering the one or more actions, and to define the one or more actions.

Example interfaces will now be described. The interfaces may be displayed on a display screen of the computing device 110. The interfaces may be displayed within the resource management application. For example, within the resource management application the user may select a selectable option to set a trigger and in response, the interfaces may be displayed.

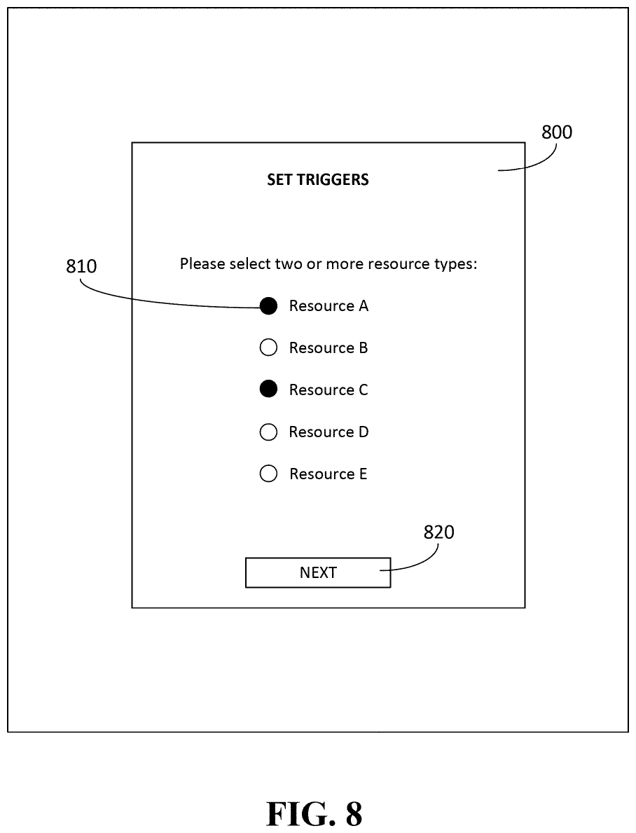

An example interface 800 used to identify the two or more resource types is shown in FIG. 8. The interface 800 includes a request to select two or more resource types and selectable interface elements 810 that, when selected, indicate selection of a particular resource type. In this embodiment, each selectable interface element 810 is in the form of a radio button that may be selected by performing, for example, a tap gesture on a display screen of the computing device 110 at a location that corresponds to the location of the radio button. The interface 800 includes a selectable option 820 to confirm selection of the two or more resource types.

In the example shown in FIG. 8, the resource types “Resource A” and “Resource C” have been selected and as such the trigger data identifies Resource A and Resource C.

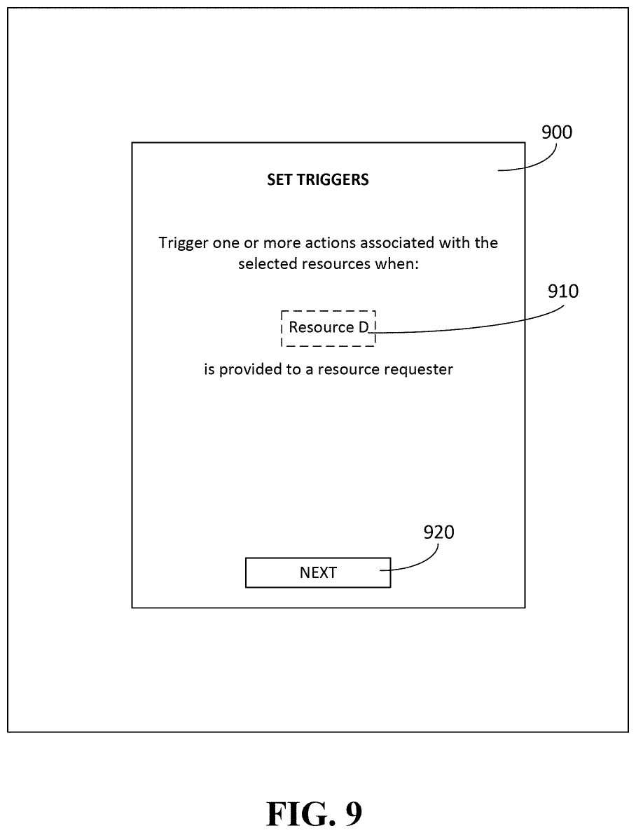

Responsive to selection of the selectable option 820 confirming selection of the two or more resource types, the computing device 110 may display an interface for defining the criteria for triggering the one or more actions. An example interface 900 used to define the criteria for triggering the one or more actions is shown in FIG. 9.

The interface 900 includes a request to define the criteria for triggering the one or more actions and a selectable interface element 910 that may be used to define the criteria for triggering the one or more actions. In this embodiment, the selectable interface element 910 is in the form of a drop-down menu. The user may select the selectable interface element 910 by performing a tap gesture on a display screen of the computing device 110 at a location that corresponds to the location of the selectable interface element 910. In response, the interface 900 may be updated to display a list of resources that may be used to define the criteria for triggering the one or more actions. The interface 900 includes a selectable option 920 to confirm selection of the criteria for triggering the one or more actions.

In the example shown in FIG. 9, the criteria selected for triggering the one or more actions includes identifying the resource type “Resource D” being provided to a resource requester. As will be described in more detail below, when it is determined that Resource D is provided to a resource requester, one or more actions may be triggered.

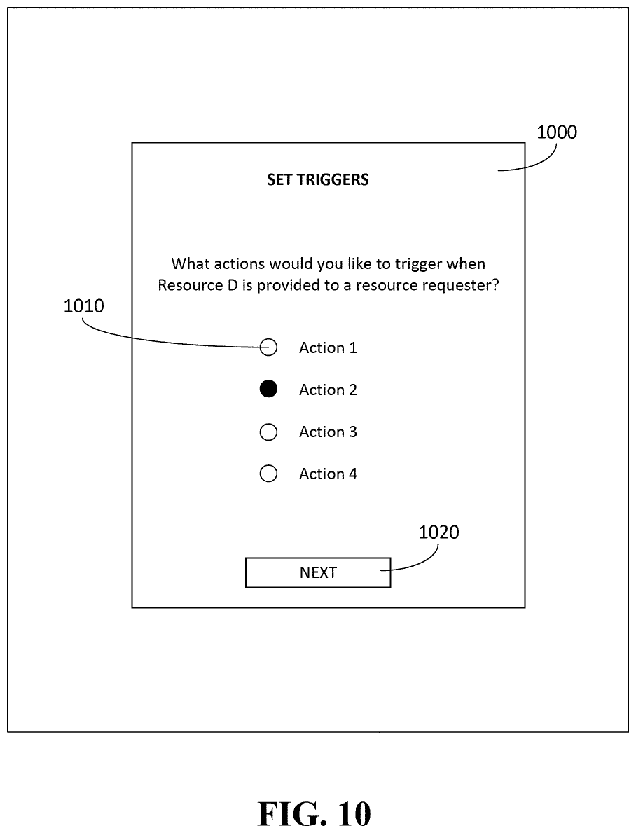

Responsive to selection of the selectable option confirming selection of the criteria for triggering the one or more actions, the computing device 110 may display an interface for defining the one or more actions. An example interface 1000 used to define the one or more actions is shown in FIG. 10.

The interface 1000 includes a request to select one or more actions and selectable interface elements 1010 that, when selected, indicate selection of a particular action. In this embodiment, each selectable interface element 1010 is in the form of a radio button that may be selected by performing, for example, a tap gesture on a display screen of the computing device 110 at a location that corresponds to the location of the radio button. The interface 1000 includes a selectable option 1020 to confirm selection of the one or more actions.

In the example shown in FIG. 10, the action selected is “Action 2”. As will be described in more detail below, when it is determined that Resource D is provided to a resource requester, Action 2 is triggered.

The method 700 includes receiving, from the computing device, a signal that includes the defined trigger data (step 720).

In this embodiment, the signal that includes the defined trigger data may be received by the server 120 in response to selection of the selectable option 1020. As mentioned, the trigger data identifies two or more resource types, criteria for triggering one or more actions associated with the one or more resource types, and the one or more actions. The trigger data may be stored in memory. For example, the server 120 may store the trigger data in the database 140 and may be stored in association with a particular account. The account may include a resource account that stores resources of a particular resource type.

The method 600 includes monitoring resource consumption data to identify another resource type being provided to a resource requester (step 620).

The another resource type is different than the two or more resource types identified in the trigger data. The resource consumption data includes a list of resource requesters and an amount of resources provided to the resource requesters. The amount of resources provided may be an amount of the another resource type provided to the resource requesters. The resources may be provided from a resource account that stores resources of the another resource type.

In this embodiment, each time resources of the another resource type are provided to a resource requester, the resource consumption data is updated. As the resource consumption data is updated, the server 120 and/or computing device 110 may monitor the resource consumption data to identify resources provided to a resource requester.

The method 600 includes determining, based on the trigger data, one or more actions to be triggered (step 630).

Responsive to identifying the another resource type being provided to the resource requester, the server 120 and/or the computing device 110 may obtain the trigger data and determine one or more actions to be triggered.

The method 600 includes triggering the one or more actions (step 640).

The server 120 and/or computing device 110 may perform operations to trigger the one or more actions. For example, the one or more actions may include performing one or more computer operations. As such, the server 120 and/or the computing device may perform operations to trigger the performance of one or more computer operations. For example, in response to identifying a particular type of computing resource being provided to a resource requester, the one or more actions may include performing computer operations to clear out the memory cache of the computing device 110. As another example, in response to identifying a particular type of computing resource being provided to a resource requester, the one or more actions may include closing one or more other applications executing on the computing device and this may be based on, for example, GPU usage of the one or more applications. In this example, an application that is high in GPU usage may be closed to ensure GPU is available for one or more other applications executing on the computing device.

The one or more actions may include providing resources of at least one of the resource types to at least one resource collector. As such, the server 120 and/or the computing device 110 may perform operations to provide resources of at least one of the resource types to at least one resource collector. For example, resources of a first resource type may be provided to a first resource collector and resources of a second resource type may be provided to a second resource collector in response to identifying the particular resource type being provided to a resource requester. As another example, resources of a first resource type may be provided to a first resource collector in response to identifying the particular resource type being provided to a first resource requester and resources of a second resource type may be provided to a second resource collector in response to identifying the particular resource type being provided to a second resource requester. As yet another, resources of a first resource type may be provided to a first resource collector in response to identifying a first amount of resources being provided to a resource requester and resources of a second resource type may be provided to a second resource collector in response to identifying a second amount of resources being provided to a resource requester.

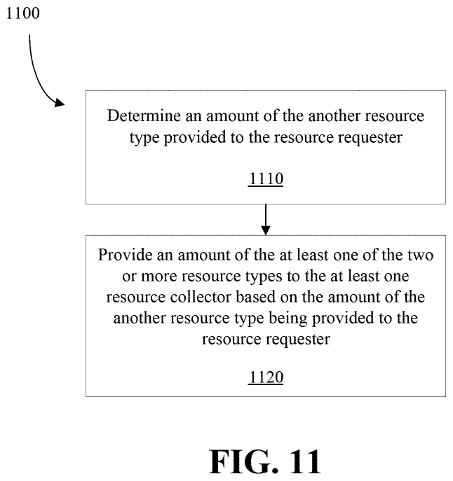

As mentioned, in one or more embodiments, the one or more actions may include providing resources of at least one of the resource types to at least one resource collector. Reference is made to FIG. 11, which illustrates, in flowchart form, a method 1100 for providing an amount of at least one of the two or more resource types to at least one resource collector. The method 1100 may be implemented by a computing device having suitable processor-executable instructions for causing the computing device to carry out the described operations. The method 1100 may be implemented, in whole or in part, by the server 120. The server 120 may off-load some of the operations to the computing device 110.

The method 1100 includes determining an amount of the another resource type being provided to the resource requester (step 1110).

As mentioned, the resource consumption data includes a list of resource requesters and an amount of resources provided to the resource requesters. The amount of resources provided may be an amount of the another resource type provided to the resource requesters. As such, the amount of the another resource type being provided to the resource requester may be determined from the resource consumption data.

The method 1100 includes providing an amount of the at least one of the two or more resource types to the at least one resource collector based on the amount of the another resource type being provided to the resource requester (step 1120).

The at least one of the two or more resource types are the resource types identified in the trigger data and are different than the another resource type being provided to the resource requester.

The at least one of the two or more resource types may be related to the another resource type. For example, the another resource type may include a first computing resource type and the at least one of the two or more resource types may include a second computing resource type. As another example, the another resource type may include a value such as a quantity of resources associated with an account such as a credit card account and the at least one of the two or more resource types may include a first loyalty point type.

In one or more embodiments, the amount of the at least one of the two or more resource types may be determined based on the amount of the another resource type. For example, the amount of the at least one of the two or more resource types may be determined based on a modifier between the another resource type and the at least one of the two or more resource types. The modifier may be a multiplier such as 2× and as such for every one (1) of the another resource type provided to the resource requester two (2) of the at least one of the two or more resource types may be provided to the resource collector. Other example multipliers may include 1×, 5×, 10×, etc. The modifier may be included in the trigger data and may be predefined or may be defined by the user in manners similar to that described herein.

In manners described herein, the trigger data may define actions associated with a first computing resource type and/or a second computing resource type that are to be performed in response to identifying a third computing resource type being provided to a resource requester. The trigger data may define a first action of throttling the first computing resource type and a second action of throttling the second computing resource type. In this example, it may be identified that the third computing resource type is being used or provided to a particular application executing on the computing device. In response, a first action may be performed to throttle the first computing resource type and/or a second action may be performed to throttle the second computing resource type. In this manner, operations may be performed to ensure a sufficient amount of the third computing resource type is available to the application executing on the computing device by throttling the first computing resource type and/or the second computing resource type.

In manners described herein, the trigger data may define actions associated with a first resource type and/or a second resource type that are to be performed in response to identifying a third resource type being provided to a resource requester. In one example, the trigger data may define a first action of providing 5× units of the first resource type to a first resource collector for every unit of the third resource type provided to a first resource requester and may define a second action of providing 3× units of the second resource type to a second resource collector for every unit of the third resource type provided to a second resource requester. In this example, it may be identified that one thousand (1000) units of the third resource type are provided to the first resource requester. As such, the first action may be performed such that five thousand (5000) units of the first resource type are provided to the first resource collector. It may additionally or alternatively be identified that one thousand (1000) units of the third resource type are provided to the second resource requester. As such, the second action may be performed such that three thousand (3000) units of the second resource type are provided to the second resource collector.

In another example, the trigger data may define a first action of providing 2× units of the first resource type to a first resource collector for every unit of the third resource type provided to a resource requester and may define a second action of providing 2× units of the second resource type to a second resource collector for every unit of the third resource type provided to a resource requester. As such, the first and second actions may be performed in response to identifying the third resource type being provided to a resource requester.

In another example, the trigger data may define a hierarchy or tier defining the one or more actions to be triggered. For example, the trigger data may define a first action of providing the first resource type for a first amount of the third resource being provided to a resource requester, a second action of providing the second resource type for a second amount of the third resource being provided to a resource requester. In examples where the third resource type is associated with an account such as a credit card account, the first amount may be the first $5000 spent on the credit card account and the second amount may be the second $5000 spent on the credit card account. In this example, a first loyalty point type may be earned for the first $5000 spent on the credit card account in a particular cycle and a second loyalty point type may be earned for the second $5000 spent on the credit card account in the particular cycle. In this manner, multiple types of loyalty points may be earned based on spending made on a single credit card account and this may be defined by the trigger data in manners described herein.

In one or more embodiments, the trigger data may only be defined by the user within the resource management application periodically. For example, the trigger data may only be defined or changed by the user once per year.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A computer server system comprising:
a communications module;
a processor coupled with the communications module; and
a memory coupled to the processor and storing processor-executable instructions which, when executed by the processor, configure the processor to:
obtain trigger data identifying two or more resource types and criteria for triggering one or more actions associated with each of the two or more resource types;
monitor resource consumption data to identify another resource type being provided to a resource requester;
responsive to identifying the another resource type being provided to the resource requester, determine, based on the trigger data, one or more actions to be triggered; and
trigger the one or more actions.

2. The computer server system of claim 1, wherein the criteria for triggering one or more actions includes identifying the another resource type being provided to the resource requester.

3. The computer server system of claim 1, wherein the one or more actions include providing resources of at least one of the two or more resource types to at least one resource collector.

4. The computer server system of claim 3, wherein the instructions, when executed, further configure the processor to:
determine an amount of the another resource type being provided to the resource requester; and
provide an amount of the at least one of the two or more resource types to the at least one resource collector based on the amount of the another resource type being provided to the resource requester.

5. The computer server system of claim 4, wherein the amount of the at least one of the two or more resource types is determined based on a modifier between the another resource type and the at least one of the two or more resource types.

6. The computer server system of claim 5, wherein the trigger data defines the modifier between the another resource type and the at least one of the two or more resource types.

7. The computer server system of claim 1, wherein the criteria for triggering the one or more actions includes triggering a first action associated with a first resource type of the two or more resource types in response to a first amount of the another resource type being provided to the resource requester and triggering a second action associated with a second resource type of the two or more resource types in response to a second amount of the another resource type being provided to the resource requester.

8. The computer server system of claim 1, wherein the criteria for triggering the one or more actions includes triggering a first action associated with a first resource type of the two or more resource types in response to the another resource type being provided to a first resource requester and triggering a second action associated with a second resource type of the two or more resource types in response to the another resource type being provided to a second resource requester.

9. The computer server system of claim 1, wherein the instructions, when executed, further configure the processor to:
send, via the communications module and to a computing device, a signal causing the computing device to display at least one interface that includes one or more interface elements for defining the trigger data; and
receive, via the communications module and from the computing device, a signal that includes the defined trigger data.

10. The computer server system of claim 1, wherein the resource consumption data includes resource consumption data stored in a database in association with a single account.

11. A computer-implemented method comprising:
obtaining trigger data identifying two or more resource types and criteria for triggering an action associated with each of the two or more resource types;
monitoring resource consumption data to identify another resource type being provided to a resource requester;
responsive to identifying the another resource type being provided to the resource requester, determining, based on the trigger data, one or more actions to be triggered; and
triggering the one or more actions.

12. The computer-implemented method of claim 11, wherein the criteria for triggering one or more actions includes identifying the another resource type being provided to the resource requester.

13. The computer-implemented method of claim 11, wherein the one or more actions include providing resources of at least one of the two or more resource types to at least one resource collector.

14. The computer-implemented method of claim 13, further comprising:
determining an amount of the another resource type being provided to the resource requester; and
providing an amount of the at least one of the two or more resource types to the at least one resource collector based on the amount of the another resource type being provided to the resource requester.

15. The computer-implemented method of claim 14, wherein the amount of the at least one of the two or more resource types is determined based on a modifier between the another resource type and the at least one of the two or more resource types.

16. The computer-implemented method of claim 15, wherein the trigger data defines the modifier between the another resource type and the at least one of the two or more resource types.

17. The computer-implemented method of claim 11, wherein the criteria for triggering the action includes triggering a first action associated with a first resource type of the two or more resource types in response to a first amount of the another resource type being provided to the resource requester and triggering a second action associated with a second resource type of the two or more resource types in response to a second amount of the another resource type being provided to the resource requester.

18. The computer-implemented method of claim 11, wherein the criteria for triggering the action includes triggering a first action associated with a first resource type of the two or more resource types in response to the another resource type being provided to a first resource requester and triggering a second action associated with a second resource type of the two or more resource types in response to the another resource type being provided to a second resource requester.

19. The computer-implemented method of claim 11, further comprising:
sending, via a communications module and to a computing device, a signal causing the computing device to display at least one interface that includes one or more interface elements for defining the trigger data; and
receiving, via the communications module and from the computing device, a signal that includes the defined trigger data.

20. A non-transitory computer readable storage medium comprising computer-executable instructions which, when executed, configure a processor to:
obtain trigger data identifying two or more resource types and criteria for triggering an action associated with each of the two or more resource types;
monitor resource consumption data to identify another resource type being provided to a resource requester;
responsive to identifying the another resource type being provided to the resource requester, determine, based on the trigger data, one or more actions to be triggered; and
triggering the one or more actions.
